(19) United States
(12) Patent Application Publication
(10) Pub. No.: US 2004/0102111 A1
(43) Pub. Date: May 27, 2004

(54) Biodegradable, pre-moistened sunscreen applicator

(76) Inventors: Joseph Francis Malcolm, Salt Lake City, UT (US); Allyson Stacey Maida, Westport, CT (US)

Correspondence Address: Allyson S. Maida, 4 North Gate, Westport, CT, 06880, US

(21) Appl. No.: 10/304,681

(22) Filed: Nov. 27, 2002

(51) Int. Cl. B32B 3/00; B32B 5/02; D04H 1/00

(52) U.S. Cl. 442/59; 442/327; 442/131

(57) ABSTRACT

A disposable, biodegradable pre-moistened sunscreen applicator (wipe) whose components are water-soluble. This flushable, non-woven fabric is sized in a manner that allows for easy to use, self administering methods. The sunscreen wipes will be saturated with a liquid sunscreen formula that is non-greasy and evenly distributed throughout the applicator.

### REFERENCES CITED

U.S. Pat. Documents

| | | |
|---|---|---|
| 6368689 | Apr. 9, 2002 | Connor Sledge, et al. |
| 6401968 | Jun. 11, 2002 | Huang, et al. |
| 6403858 | Jun. 11, 2002 | Quincy, III, et al |
| 6361784 | Mar. 26, 2002 | Brennan, et al. |
| 5968853 | Oct. 19, 1999 | Kelly, et al. |
| 6153700 | Nov. 28, 2000 | Wang, et al. |
| 5629081 | May 13, 1997 | Richards, et al. |
| 5667635 | Sep. 16, 1997 | Win, et al. |
| 5762948 | Jun. 9, 1998 | Blackburn, et al. |
| 6399045 | Jun. 4, 2002 | Morgan, et al. |
| 6383614 | May 7, 2002 | Carson, et al. |
| 6362256 | Mar. 26, 2002 | Willett, et al. |
| 6182418 | Feb. 6, 2001 | McFarland |
| 5740913 | Apr. 21, 1998 | McFarland |

### BACKGROUND OF THE INVENTION

It is known that at present there are a variety of pre-moistened wipes that are utilized for the purposes of cleaning both households and the human body. Furthermore, some of these wipes are also used to moisturize and cleanse animal teats. There are also water-moistened soluble pre-moistened wipes available on the commercial market, however, the purpose of these products is specifically for cleansing for babies and general bodily hygiene. Currently, there are pre-moistened, sunscreen wipes and towelettes available commercially in the form of small hand held sizes (12″×12″) Through the searches conducted for the purposes of this Patent Application it has been determined that there are not any pre-sunscreen moistened sunscreen applicators or towelettes that are biodegradable. Furthermore, existing sunscreen wipe products are not lengthy enough to apply sunscreen products on hard to reach places, such as one's back, without assistance. The closest method of self-application for difficult to reach areas is provided by spray mechanisms that disperse sunscreen which often partially miss the area for which the sunscreen is intended for. Therefore, this invention may be measured from anywhere between 5 ½″×6″ to 25″×6″.

One of the greatest problems with existing sunscreen wipes is the issue of disposability and ecological value. The existing sunscreen wipe's “fabrics” are made of synthetic materials that do not break down. They must be thrown away in a garbage receptacle in order to be disposed of The sunscreen wipes that are outlined in this patent application are also to be appropriately disposed of, however, they are biodegradable as they may be made of wood pulp, water and material stabilizers. The composition of this material dissipates when submerged in water. Therefore, the product is flushable and in cases of bad judgment, will dissolve into biologically based material that will not pollute the land on which it is disposed of. Therefore, these water soluble wipes will be able to be flushed down a toilet, causing no harm to the septic or plumbing system, or if inappropriately disposed of, will be of no biological hazard.

There is a need for dispensable, biodegradable sunscreen wipes that provide easy to use one step applications to all areas of the body. In the case of the utilization of wipes that are measured 25″×6″, the application of sunscreen can be made independently by the user. The present invention produces moist wipes that are saturated with liquid sunscreen that is easy to apply and store. With benefits of protection for those who are exposed to ultra violet light, this consumable product is extremely user and ecologically friendly.

### BRIEF SUMMARY OF THE INVENTION

This hand held biodegradable pre-moistened sunscreen applicator has been developed to provide the user with the ability to independently apply sunscreen upon their own body. This invention may be measured anywhere from 5 ½×6″ for easy to hold, hand sized application, to 25″×6″ lengths that are to be held at each end of the applicator in order to apply, in a sweeping motion, sunscreen to one's back and other difficult to reach places on the human body.

### FIGURE DESCRIPTION

FIGS. 1, 2 & 3: The 5 ½″×6″ (13.9×15.2 cm) are disposable, biodegradable sunscreen wipes which are tri-folded in order to provide the user with easy grip, dispensement, maintenance and utilization of the product. Each wipe will be pre-moistened with sunscreen in order to provide easy application for the user of the product.

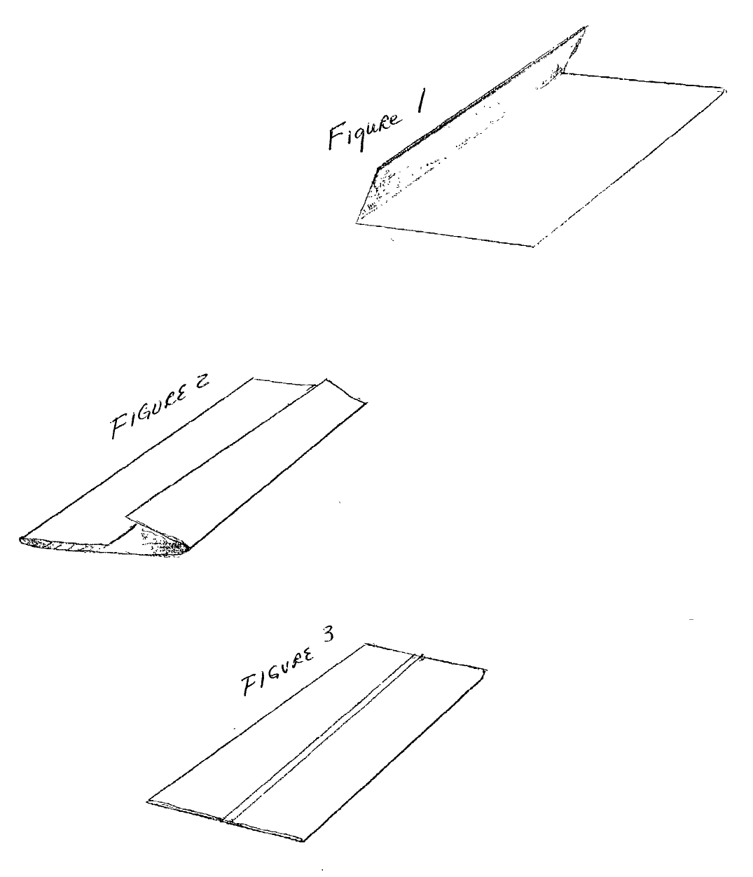

FIGS. 4 & 5: The lengthier wipes, measured at 25″×6″ will facilitate easy utilization for areas that are difficult to reach areas without assistance from another person. As seen in FIGS. 4 and 5 the longer wipes may be perforated in order to allow for use of smaller portions of material or lengthier ones at the discretion of the user.

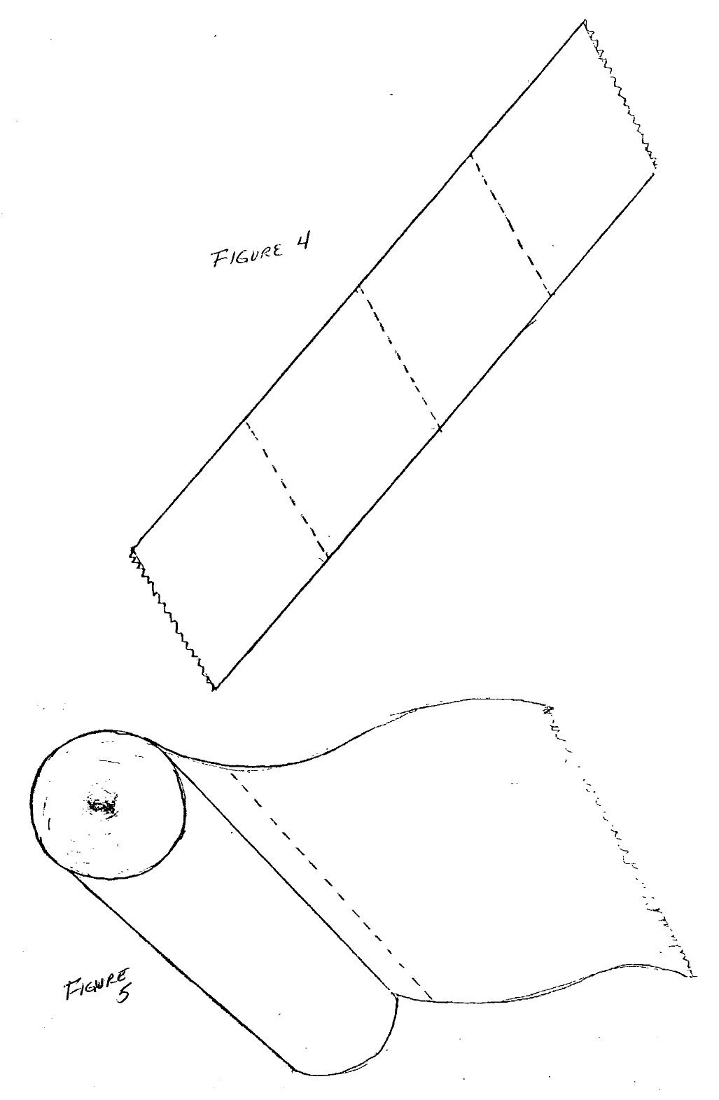

### DETAILED DESCRIPTION

This application is related to Provisional Application # 60/389,545 filed on Jun. 19, 2002.

The product is a hand-held, biodegradable, disposable sunscreen applicator (wipe). The components of the sunscreen may be water, sorbitan oleate, sorbitol, sorbitan sterate, glycerin, sterrate SE, sterrate acid, octadecene/MA, copolymer, triethanolamnine and Aloe Vera. The sunscreen which saturates the disposable, wipes will be that of a liquid consistency. In addition to the benefit of Ultra Violet light protection, this invention provides an easy to use, one step application that can be applied to the exterior of the human body. The length and width of the wipe are designed to allow for easy access and application to places on the body that are often difficult to reach on one's own, with the most common example being one's back.

This single invention has distinct characteristics that allow for the user to meet a variety of needs relating to sunscreen application and applicator disposal. The longer product will be 25″×6″ which may be dispensed through a pop-up, center-pull dispenser which will assist in maintaining the moistness of the sunscreen product within the wipe, providing easy disbursement and containment. The invention provides for the longer wipes to have perforations that will allow for the product to be utilized in it's lengthier form or to be separated at perforations that allow to use of lesser material. The smaller of the products will be 5 ½″×6″ which provides the user with as hand-sized product that may be dispensed from a container that maintains tri-fold wipes in a layered, inter-fold manner.

In the case of the 25″×6″ sunscreen wipe, the user may hold each end of the applicator in order to apply sunscreen to their back and difficult to reach areas by moving the applicator back and forth with a sweeping motion. Presently, there are not any applicators with length that provide the opportunity for this particular method of self-application of sunscreen. The closest method of self-application for difficult to reach areas is provided by spray mechanisms that disperse sunscreen, often partially missing the area in which the sunscreen is intended for.

I. We claim that our invention is a biodegradable, sunscreen applicator that is made of materials that are flushable and dissipate when submerged in water.

II. We claim that our invention is a hand-held sunscreen applicator that is lengthy enough to apply sunscreen independently to areas that are most difficult to reach, such as one's back.

III. We claim that our invention is a hand held sunscreen applicator that is able to be utilized in short measure, such as 5 ½″×6″ up to greater lengths, such as 25″×6″ which facilitates a tailored approach to making sunscreen application conventional and easy for the user.
